(19) United States
(12) Patent Application Publication
(10) Pub. No.: US 2017/0351699 A1
(43) Pub. Date: Dec. 7, 2017

(54) FILE VALUE FILE REPLICATION

(71) Applicant: Hewlett Packard Enterprise Development LP, Houston, TX (US)

(72) Inventors: Yvon P Queromes, Plano, TX (US); Ashok Chandnani, Pontiac, MI (US)

(21) Appl. No.: 15/538,507

(22) PCT Filed: Dec. 22, 2014
(86) PCT No.: PCT/US2014/071854

§ 371 Date: Jun. 21, 2017

(51) Int. Cl. G06F 17/30

(52) U.S. Cl. CPC G06F 17/30174; G06F 17/30085; G06F 17/30212

(57) ABSTRACT

A file access event relating to a file may be detected. A local file value rule may be applied to modify a local value of the file in response to the file access event. A local file replication rule may be applied using the modified local value to determine whether to replicate the file.

### BACKGROUND

Digital asset repositories, such as digital media repositories may form components of digital asset management systems or media asset management systems that provide storage management. For example, media objects may be managed using storage systems, such as online, near line, and offline hierarchical storage management (HSM) systems. These systems may provide backup, archival, and disaster recovery services.

### BRIEF DESCRIPTION OF THE DRAWINGS

Certain examples are described in the following detailed description and In reference to the drawings, in which:

FIG. 1 illustrates an example system including two storage nodes with asymmetric file replication and retention;

FIG. 2 illustrates an example method of maintaining local file values and performing local file replication decisions;

FIG. 3 illustrates an example method of maintaining local file values, performing local file replication decisions, and performing a purge process;

FIG. 4 illustrates an example system including an event detector, file value controller, file value store, and file replication controller;

FIG. 5 illustrates an example system including an event detector, a file value controller, a file replication controller, file value store, and a file retention controller; and

FIG. 6 illustrates an example system including a non-transitory computer readable medium storing instructions executable by a processor 603 to manage file values, file replication, and file deletions.

### DETAILED DESCRIPTION OF SPECIFIC EXAMPLES

The large file sizes of digital media files often require high network bandwidth to be made available for replication and retrieval across geographical dispersed nodes. Additionally, such files often occupy large pools of storage. which may be costly to keep available online. For example, the majority of files may be rarely used by users, which may result in disk space, power, and processing resources being wasted keeping this data online at multiple nodes. Additionally, in many industry segments, such as news, advertising, entertainment, education, publishing, and product design, different nodes may place different values on digital assets.

Aspects of the disclosed technology allow asymmetric distributed replication and retention across nodes in a media management system. For example, the relative value of the media file at each node may be used to determine if and when a copy of the media file should be copied to a remote node. The relative value may also be used to modify the file retention period at each node.

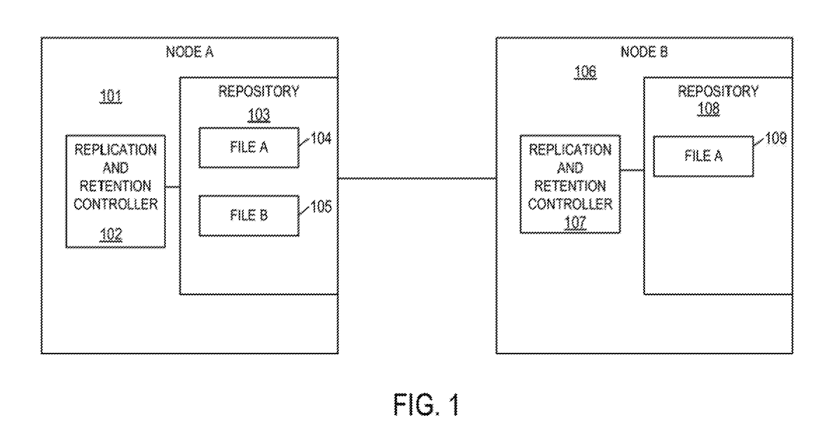

FIG. 1 illustrates an example system Including two storage nodes 101, 106 with asymmetric fife replication and retention. For example, the Node A 101 may be a workstation and Node B 106 may be an online backup system or web server. Each node 101 and 106 has a replication and retention controller 102, 107. Each controller 102, 107 applies local replication and retention rules to determine whether to replicate and retain stored files 104, 105, 109. For example, the local replication and retention rules may depend on a local file value for each file 104, 105, and 109. Each controller 102, 107 may determine the local value for the files, 104, 105, 109 depending on events related to the file that occur ors the respective nodes 101, 106.

In some cases, the controllers 102, 107 monitor file access events on the nodes 101, 106 and increments file values for files that are accessed. For example, a copy of File A 104 stored In repository 103 may have its value increased by the controller 102 if the controller 102 detects a purchase of the file 104 or a printout thereof from node 101. As another example, a copy 109 of File A 104 stored on a web server 106 may have its value increased by the controller 107 if the controller 107 detects that the file is viewed, purchased, or shared. Accordingly, copies 104, 109 of the same File A may have different values on the different nodes 101, 106 depending on how they are treated at the different nodes.

The controllers 102, 107 may execute local retention rules to control the replication of the files 104, 105, 109 on the nodes 101, 106. For example, each time a file 104 is accessed on node 101, its value may be incremented by a certain amount. If the file value exceeds a threshold, it may be replicated onto node 106. The controller 107 may assign the received copy 109 a default file value. The controller 107 may then increment the copy's 109 file value based on file access events that occur on node 106, in the illustrated example, File B 105 may have an insufficient number of file access events to raise its value over the threshold to replicate the file 105 onto node 106.

In some cases, each controller 102, 107 may execute local retention rules to control the retention of the files 104, 105, 109 on the nodes 101, 106. For example, each controller 102, 107 may delete fit files 104, 105, 109 in the respective repositories 103, 108 based on factors such as local file value, age, or time since last accessed. Additionally, each controller 102, 107 may decrement the local file values of the files 104, 105, 109 at set rates. In some cases, these rates may be determined on a node-by-node basis, such that controller 102 decrements values at a different rate than controller 107. In further cases, these rates may be determine on a file-by-file basis For example, at file creation, the decrement rate may be provided as metadata.

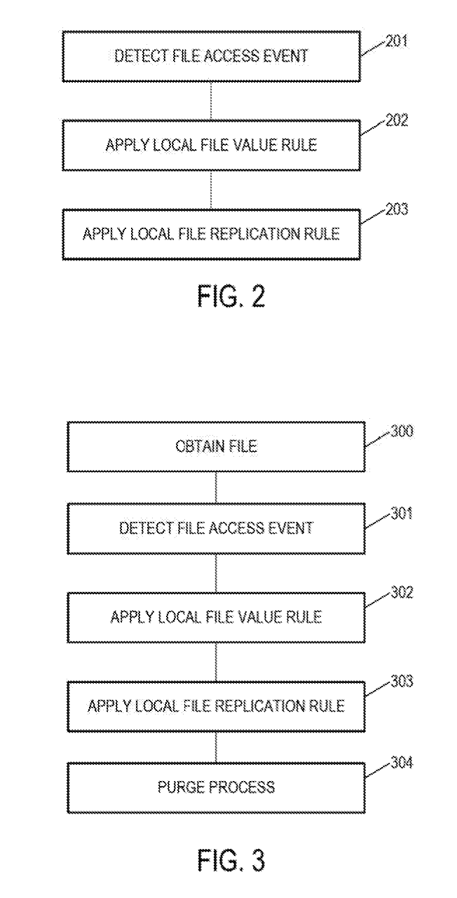

FIG. 2 illustrates an example method of maintaining local file values and performing local file replication decisions. In some implementations, the illustrated method may be performed by various nodes within a media management system. For example, the example method may be performed by media management nodes such as node A 101 or node B 106 of FIG. 1. For example, the nodes of the media management system may include workstation, servers, virtual machines which may be hosted on a cloud system, backup systems, web servers, nodes in a content distribution network (CDN), storage area networks (SAN), or other components of media management systems capable of storing files. In some cases, the illustrated method may improve storage capacity utilization and preserve storage resources locally as over an aggregate of the nodes.

The example method may include block 201. Block 201 may include detecting a file access event renting to a file stored locally on the system performing the method. The detected file access event may include various operations that may be performed in relation to a file. For example, the file access event may be a purchase event, where a user purchases a copy of the file or a content item created from the file, such as a photograph. As another example, the fife access event may be a view or open event, where the file is viewed or opened on a workstation. As further example, the file access event may be a download event where the file is downloaded by a user from the node. In a further example, the file access event may be a share event where the file is shared or a link to the file is sent on a social network or over a messaging service. As another example, the file access event may be a fag event where the file is tagged on a social media node, tagged as a favorite, had new metadata associated with the file, or otherwise marked as a valued file.

In various implementations, the file access event may be detected in various manners. For example, block 201 may foe performed by an event listener that monitors key event and messages that may be used to infer events based on the observations. For example, the event listener may monitor operating system events or event feeds. As another example, block 201 may be performed by using an application programming interface (API) exposed to other applications and workflows accessing the file. For example, the API may be used to receive indications of file access events, such as file views, file downloads, file purchases, file shares, and fie tagging.

Block 202 may include applying a local file value rule to modify a local value of the file in response to the file access event. For example, block 202 may include incrementing the local value of the file in response to a file access event. In some implementations, the local file rule may increment the local value by a first amount for a first type of file access event and Increment the local value by a second amount for a second type of file access event. For example, block 202 may include incrementing the value by X for a file view and Y for a purchase, where X and V are different numbers. Additionally, the local file rule may increment the local value when a certain number of file access events occur. For example, a file access rule may increment the local value by X for every N file views, where X is the increment amount and N is a number of file views. As an example, the local file value rule may have a first sub-rule to increment the file value by X for every 1000 views and a second sub-rule to increment the file value by Y for every 10 purchases.

In some implementations, different nodes applying the same set of rules may have different local file values for copies of the same file. For example, Node 1 may have a value of 1000 for File A after 1000 views of the file at Node 1. Node 2 may store a copy of the same File A, but may only have a value of 500 for the file, as a result of only 500 views of the file at Node 2. In further implementations, different nodes may have different, node-specific, rules. For example, different nodes may have different values of X and N in a rule that states to increment the file value by X every N events.

Additionally, different nodes may have rules that are conditioned on different events. For example, a workstation at an amusement park may have a node-specific rule that a picture file has its value increased every time it is purchased. In this example, a web server (at a different node) that receives copies of picture files from the workstation may have rules that file values are increased after a certain number of file downloads or shares are performed using the web server.

In some implementations, block 202 may include storing the file values in association with their respective files. In some cases, each file's value may be stored in the file's extended metadata. Additionally, block 202 may include storing other information associated with the files and used to determine the file values. For example, block 202 may include storing event types that have occurred, and the counts of those events, timestamps of events, an indication of the last event that occurred and its timestamp, a Uniform Resource Identifier (URI) to the file, original location of the file, previous location of the file, or other user-defined fields. For example, underlying file system extended file attributes may be used to store indicators and relevant metadata.

The example method further includes block 203. Block 203 may include applying a local file replication rule using the modified local value to determine whether to replicate the file. For example, the local fife replication rule may indicate a threshold that, when exceeded by the local file value, triggers the file to be marked for replication to another node. In some implementations, block 203 may include performing the replication to the selected node. In other implementations, block 203 may Include marking the file for replication to the selected node and existing replication processes may perform the replication.

In some implementations, the local file replication rule may include a set of sub-rules that indicate various conditions for replicating the file to various nodes. For example, a set of rules may have various thresholds and various destinations based on the thresholds. For example, the replication rule may include a sub-rule that indicates sending the file to a first set of nodes when a first threshold is met and a second sub-rule that indicates sending the file to a second set of nodes when a second threshold is met, in further implementations, the local file replication rule may include other conditions, such as file type conditions, last event conditions, or age conditions. For example, a set of sub-rules may be as followed:
1. If file value>X and file type=video, then copy to node B
2. If file value>Y and last event=modify file, then copy to node B and C
3. If file value>Z, then copy to node D.

In various implementations, the replication rules may enforced at each node independently. With each node Independently performing file value calculations, different nodes may perform different replication processes. This may result in asymmetric distribution of files across the management system. For example, in an animation studio, with the above example, node D may be a network storage with high bandwidth. If a workstation performing the replication rules has a high valued asset (for example, a computer animation file with many recent edits and many recent views), this asset may be automatically replicated to the high bandwidth network storage node D, allowing other workstations rapid access to the file. Lower valued assets, such as animation files that are infrequently used may be transferred to network storage with lower available transfer speeds.

In further implementations, the replication rules may vary at the different nodes. For example, different nodes may have different numbers of rules, thresholds and conditions may be different at different nodes, or replication destinations may be different at different nodes.

FIG. 3 illustrates an example method of maintaining local fie values, performing local file replication decisions, and performing a purge process. For example, the method of FIG. 2 may be performed as a subset of performing the method of FIG. 3. In some implementations, the illustrated method may be performed by various nodes within a media management system. For example, the example method may be performed by media management nodes such as node A 101 or node B 106 of FIG. 1. For example, the nodes of the media management system may include workstation, servers, virtual machines which may be hosted on a cloud system, backup systems, web servers, nodes in a content distribution network (CDN), storage area networks (SAN), or other components of media management systems capable of storing files. In some cases, the illustrated method may improve storage capacity utilization and preserve storage resources locally as over an aggregate of the nodes.

The example method may include block 300. Block 300 may include obtaining the file to be evaluated and replicated. For example, block 301 may include creating the file at the node performing the method, obtaining the file from a connected device or storage system, or obtaining the file through a transfer from another node. In some implementations, block 300 may include receiving the file from a file management system node, and setting an initial local value of the file to a default file value. By setting the initial local value of the file to a default file value, the previous value of the file at the pervious system node may be ignored by the receiving node. Accordingly, the receiving node may perform an independent valuation of the file based on the value of the file to the receiving system.

In some implementations the default file value may be dependent on various conditions. For example, the default file value may vary based on the source node of the file, the file type, or file metadata, such as the file value at the source node, or other extended metadata stored by the source node.

The example method may further include block 301. Block 301 may include detecting a file access event relating to the file obtained in block 300. Block 301 may be performed as described with respect to block 201 of FIG. 2.

The example method may further include block 302. Block 302 may include applying a local file value rule to modify a local value of the file in response to the file access event. Block 302 may be performed as described with respect to block 202 of FIG. 2.

The example method may further include block 303. Block 303 may include applying a local the replication rule using the modified local value to determine whether to replicate the file. Block 303 may be performed as described with respect to block 203 of FIG. 3.

The example method may further include block 304. Block 304 may include performing a purge process on the file. In some implementations, the purge process may include decrementing the local value at a rate. For example, block 304 may include decrementing the local value by Z every N days, where Z and N are integers. For example, the local file value may be decremented by 1 every 90 days. In some implementations, the values of Z and N may be the same for every file stored on the node. In other Implementations, Z or N may vary because of various factors, such as file type, source of file, age of file, or other file metadata. Additionally, Z or N may be different at different nodes of the file management system.

Block 304 may further apply a file retention rule using the local file value modified in block 302 to determine whether to retain the file. For example, after decrementing the local value, block 304 may include deleting the file if the focal value is below a lie deletion threshold. In some implementations, the file deletion threshold may depend on various factors such as age of the file, file type, last access time, or other file information. For example, applying the file retention rule may include sub-rules such as:
1. If file value<X and file is older than A days, delete file.
2. If file value<V and file is older than B days, delete file.
3. If file value<Z and last view of file is more than C days, delete file.
   In some implementations, the file retention rules may be defined specifically for the node executing the method. Accordingly, different nodes in a file management system may store files for different lengths of time even if file values for copies of the same file are equal.

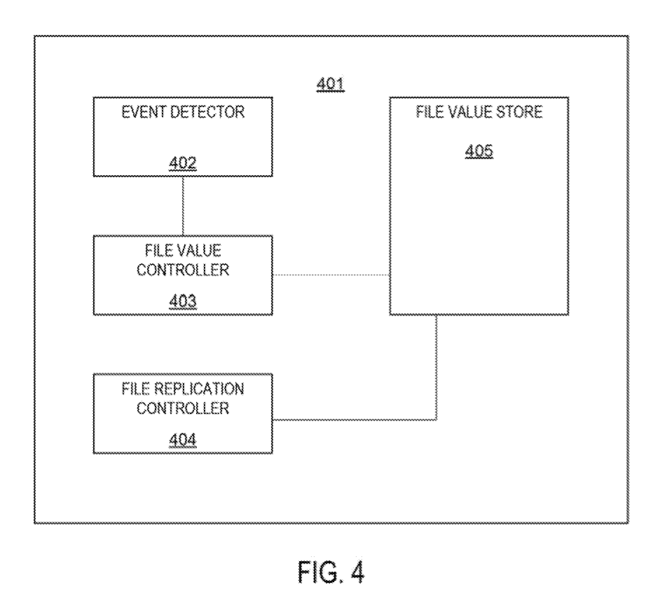

FIG. 4 illustrates an example system 401 including an event detector 402, file value controller 403, file value store 405, and the replication controller 404. For example, the illustrated system 401 may be a node of a file management system, such as one of the storage nodes 101, 106 described with respect to FIG. 1. Additionally, the illustrated system 401 may perform a method such as the method described with respect to FIG. 2 or FIG. 3. In various cases, the illustrated functional modules may be implemented as hardware, as software stored on a non-transitory computer readable medium and executed by a processor, or a combination thereof.

The example system 401 may include an event detector 402. The event detector 402 may detect an access event of a file. For example, the event detector 402 may operate as described with respect to block 201 of FIG. 2. For example, the event detector 402 may include an event listener that that monitors key event and messages that may be used to Infer events based on the observations. For example, the event detector 402 may include a listener that monitors operating system events or event feeds. And in another example, the event detector 402 may include an API exposed to other applications and workflows that access the file. The API of the event detector may be used to allow direct manipulation of file values or to receive indications of file access events, such as file views, file downloads, file purchases, file shams, and file tagging.

The example system 401 may further include a file value controller 403. The file value controller 403 may increment a local file value in response to the access event detected by the event detector 402. For example, the file value controller 403 may operate as described with respect to block 202 of FIG. 2. In some implementations, the file value controller 403 may store the file values in a file value storage 405. For example, the file value storage 405 may be the file's extended metadata supported by the file system used to store the file. In further implementations, the file value controller 403 may store further information in storage 405. For example, controller 403 may use storage 405 to store event types that have occurred, and the counts of those events, timestamps of events, an indication of the last event that occurred and its timestamp, a Uniform Resource Identifier (URI) to the file, original location of the file, previous location of the file, or other user-defined fields.

In some implementations, the file value controller 403 may increment the local file value by a first amount in the case of a first type of file access event and Increment the local file value by a second amount in the case of a second type of file access event. Additionally, the file value controller 403 may set the local file value indicator to a default value when the file is first stored. For example, the file value controller 403 may operate as described with respect to block 300 of FIG. 3.

The example system may further include a file replication controller 404. The file replication controller 404 may use the local file value to determine whether to replicate the file. For example, the file replication controller 404 may operate as described with respect to block 203 of FIG. 2. Additionally, in some cases, the file replication controller may use the local file value to select where to copy the file during a replication process.

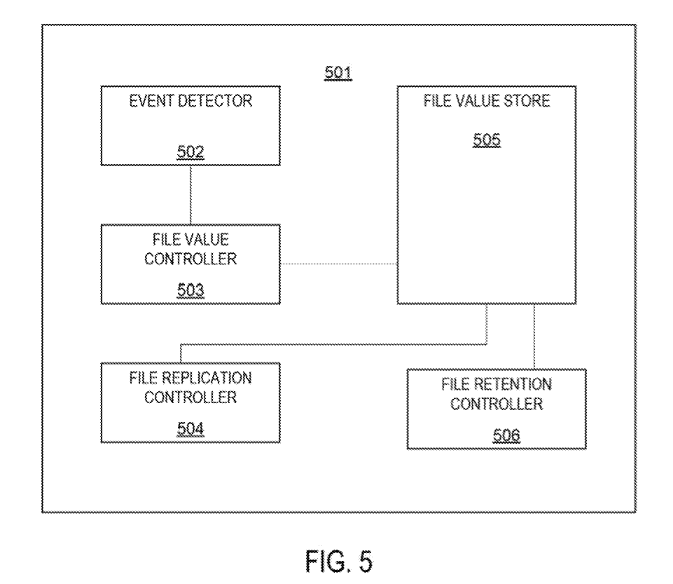

FIG. 5 illustrates an example system 501 including an event detector 502, a file value controller 503, a file replication controller 504, file value store 505, and a file retention controller 506. For example, the illustrated system 501 may be a node of a file management system, such as one of the storage nodes 101, 106 described with respect to FIG. 1. Additionally, the illustrated system 501 may perform a method such as the method described with respect to FIG. 2 or FIG. 3. In various cases, the illustrated functional modules may be implemented as hardware, as software stored on a non-transitory computer readable medium and executed by a processor, or a combination thereof.

The event detector 502, file value controller 503, file replication controller 504 and file value store 505 may be as described with respect to event detector 402, file value controller 403, file replication controller 404, and file value store 405 of FIG. 4, respectively.

Additionally, the example system 501 may include a file retention controller 506 The file retention controller 506 may use the local file value to determine whether to delete the file. For example, the file retention controller 506 may use the local file value to perform a purge process as described with respect to block 304 of FIG. 3.

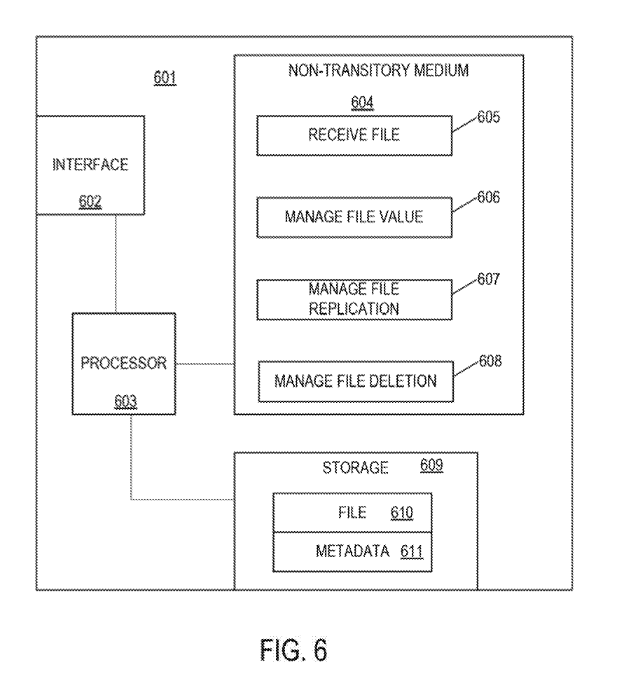

FIG. 6 illustrates an example system 601 including a non-transitory computer readable medium 604 storing instructions 605-608 executable by a processor 603 to manage file values, file replication, and file deletion. For example, the system 601 may be a node of a file management system, such as one of the storage nodes 101, 106 described with respect to FIG. 1, or a system 401 or 501 described with respect to FIGS. 4 and 5, respectively. In some implementations, the non-transitory computer readable medium 604 may include memory, storage, or a combination thereof.

The illustrated medium 604 may store instruction set 605. Instruction set 605 may be executable by the processor 603 to use an interface 602 to receive a file. In some cases, instructions 605 may be executable to perform block 300 of FIG. 3. For example, the interface 602 may be a Universal Serial Bus (USB) or other peripheral device interface, and the instruction set 605 may be executable by the processor 603 to retrieve the file from a peripheral, such as a camera. As another example, interface 602 may be a network interface, and instructions 605 may be executable to receive a file from a node of a file management system. Additionally, instructions 605 may be executable by the processor 603 to store the file 610 in a data storage 609. For example, the data storage 609 may be a storage volume of the system 601, a network attached storage (NAS), a volume on a storage area network (SAN), or other storage.

The illustrated medium 604 may also store instruction set 606. Instruction set 606 may be executable by the processor 603 to control local file values. For example, the instruction set 606 may be executable by the processor 603 to set a local file value for the file to a local default value. Additionally, the instruction set 606 may be executable by the processor 603 to detect m assess event for the file. For example, the instruction set 606 may be executable to cause tie processor 603 to perform block 201 or 361 of FIG. 2 or 3, respectively.

The instruction set 606 may be further executable to cause the processor 603 to increment the local file value based on a type of access event. For example, the instruction set 606 may be executable by the processor 603 to perform block 202 or 302 of FIG. 2 or 3, respectively. Additionally, the instruction set 606 may be further executable to cause the processor 603 to store the local file value in the metadata 611 associated with the file 610.

The illustrated medium 604 may also store instruction set 607. Instruction set 607 may include instructions to manage replication of the file to other nodes of the file management system. For example, the instructions 607 may be executable to mark the file for replication if the local file value exceeds a replication threshold. For example, the instructions 607 may be executable to mark the file for replication to a first node if the local file value exceeds a first replication threshold, and mark the file for replication to a second node if the local file value exceeds a second replication threshold. For example, the instructions 607 may be executed by the processor to perform blocks 203 or 303 of FIG. 2 or 3, respectively.

The illustrated medium 604 may also store instruction set 608. Instruction set 608 may be executable by the processor 603 to manage file deletion from the storage 609. For example, instructions 608 may be executable by the processor 603 to mark the file for deletion if the local file value is less than a file deletion threshold. In some cases, file deletion threshold may be dependent on an age of the file. For example, instruction set 608 may be executable by the processor to perform block 304 of FIG. 3.

In the foregoing description, numerous details are set forth to provide an understanding of the subject disclosed herein. However, Implementations may be practiced without some or all of these details. Other implementations may include modifications and variations from the details discussed above. It is intended that the appended claims cover such modifications and variations.

1. A method, comprising:
detecting a file access event relating to a file;
applying a local file value rule to modify a local value of the file in response to the file access event; and
applying a local file replication rule using the modified local value to determine whether to replicate the file.

2. The method of claim 1, wherein the local file value rule increments the local value by a first amount for a first type of file access event and increments the local value by a second amount for a second type of file access event.

3. The method of claim 1, wherein the local file replication rule indicates replication of the file to a first node if the modified local value meets a first threshold and indicates replication of the file to a second node if the modified local value meets a second threshold.

4. The method of claim 1, further comprising:
receiving the file from a file management system node; and
setting an initial local value of the file to a default file value.

5. The method of claim 1, further comprising:
applying a local fie retention rule using the local value to determine whether to retain the file.

6. The method of claim 1, further comprising:
decrementing the local value of the file at a rate; and
deleting the file if the local value is below a file deletion threshold.

7. A system, comprising:
an event detector to a detect an access event of a fife;
a file value controller to increment a local file value in response to the access event; and
a file replication controller to use the local file value to determine whether to replicate the file.

8. The system of claim 7, wherein the file value controller increments the local file value by a first amount in the case of a first type of file access event and increments the local file value by a second amount in the case of a second type of file access event.

9. The system of claim 7, wherein the file value controller sets the local file value indicator to a default value when the file is first stored.

10. The system of claim 7, wherein the file replication controller is to use the local file value to select where to copy the file during a replication process.

11. The system of claim 7, further comprising:
a file retention controller to use the local file value to determine whether to delete the file.

12. A non-transitory computer readable medium storing instructions executable by a processor to:
receive a file from a node of a file management system;
set a local file value for the file to a local default value;
detect an access event for the file;
increment the local file value based on a type of access event; and
if the local file value exceeds a replication threshold, mark the file for replication.

13. The non-transitory computer readable medium of claim 12, storing further instructions to:
mark the file for replication to a first node if the local file value exceeds the first replication threshold; and
mark the file for replication to a second node if the local file value exceeds a second replication threshold.

14. The non-transitory computer readable medium of claim 12, storing further instructions to:
mark the file for deletion if the local file value is less than a file deletion threshold.

15. The non-transitory computer readable medium of claim 14, wherein the file deletion threshold is dependent on an age of the file.
